(19) United States
(12) Patent Application Publication
(10) Pub. No.: US 2024/0242878 A1
(43) Pub. Date: Jul. 18, 2024

(54) PLANAR TRANSFORMER

(71) Applicant: DELTA ELECTRONICS, INC., Taoyuan City (TW)

(72) Inventors: Po-Yi KUO, Taoyuan City (TW); Hao-Peng CHENG, Taoyuan City (TW); Chia-Hsiong HUANG, Taoyuan City (TW); Yu-Jen LIN, Taoyuan City (TW)

(21) Appl. No.: 18/305,705

(22) Filed: Apr. 24, 2023

(30) Foreign Application Priority Data
Jan. 17, 2023 (CN) 202310059482.7

(51) Int. Cl. H01F 27/28

(52) U.S. Cl. CPC H01F 27/2885; H01F 27/2804; H01F 2027/2809; H01F 2027/2819

(57) ABSTRACT

A planar transformer includes: a first primary winding layer; a second primary winding layer disposed adjacent to the first primary winding layer; a shielding layer disposed adjacent to the first primary winding layer; a first secondary winding layer disposed adjacent to the shielding layer; a second secondary winding layer disposed adjacent to the first secondary winding layer. The first primary winding layer and the second primary winding layer are located at one side of the shielding layer. The first secondary winding layer and the second secondary winding layer are located at another side of the shielding layer.

### BACKGROUND OF THE DISCLOSURE

### Technical Field

The disclosure relates to a transformer, particularly relates to a planar transformer.

### Description of Related Art

In the related art, the high-end power product is developed toward high efficiency and high power density. Following the requirement of the power density for the switching power supply, high work frequency and planarized transformer are broadly applied. When the work frequency is higher, the volume of the transformer is smaller, and thus the planar transformer is more advantageous than the traditional transformer in volume and flexibility.

The consistency of the planar transformer is better than the traditional winding transformer. However, in the laminate structure of related art, the interlayer capacitance from the shielding layer may influence the switching speed of the switching power supply under high-frequency operation, and further decrease the operation efficiency.

In view of this, the inventors have devoted themselves to the aforementioned related art, researched intensively try to find a structure for the planar transformer to decrease the interlayer capacitance.

### SUMMARY OF THE DISCLOSURE

The disclosure provides a planar transformer, which may decrease the interlayer capacitance and improve the switching speed of the switching power supply.

The disclosure provides a planar transformer includes: a first primary winding layer; a second primary winding layer, disposed adjacent to the first primary winding layer; a shielding layer, disposed adjacent to the first primary winding layer; a first secondary winding layer, disposed adjacent to the shielding layer; and a second secondary winding layer, disposed adjacent to the first secondary winding layer. The first primary winding layer and the second primary winding layer are located at one side of the shielding layer, and the first secondary winding layer and the second secondary winding layer are located at another side of the shielding layer.

In some embodiments, a distance between the first primary winding layer and the shielding layer is in a predetermined range. In some embodiments, the predetermined range is equal to or greater than 0.4 mm and equal to or less than 0.6 mm.

In some embodiments, a distance between the first secondary winding layer and the shielding layer is in a predetermined range. In some embodiments, the predetermined range is equal to or greater than 0.4 mm and equal to or less than 0.6 mm.

In some embodiments, a distance between the first primary winding layer and the shielding layer is the same with a distance between the first secondary winding layer and the shielding layer.

In some embodiments, a lateral width of the first primary winding layer is less than a lateral width of the shielding layer. In some embodiments, a lateral width of the first secondary winding layer is less than a lateral width of the shielding layer.

The disclosure alternatively provides a planar transformer includes: a shielding layer; a first primary winding layer, located at one side of the shielding layer; a first secondary winding layer, located at another side of the shielding layer; a second primary winding layer, located one side of the first primary winding layer opposite to the shielding layer; and a second secondary winding layer, located one side of the first secondary winding layer opposite to the shielding layer.

The disclosure alternatively provides a planar transformer includes: a primary winding set, comprising at least two primary winding layers; a secondary winding set, comprising at least two secondary winding layers; and a shielding layer, located between the primary winding set and the secondary winding set.

In some embodiments, a distance between the primary winding set and the shielding layer is in a predetermined range. In some embodiments, a distance between the secondary winding set and the shielding layer is in a predetermined range.

In some embodiments, a distance between the primary winding set and the shielding layer is same with a distance between the secondary winding set and the shielding layer.

In summary, the planar transformer of the disclosure is structured by respectively arranging two primary winding layers and two secondary winding layers at two sides of one shielding layer. As a result, comparing to the related-art structure, the interlayer capacitance from the shielding layer is decreased, the switching speed of the switching power supply may not be influenced under high-frequency operation, and the decreasing of the operation efficiency may be further prevented. In other words, the planar transformer of the disclosure may decrease the interlayer capacitance from the shielding layer and decrease the efficiency loss during high-frequency operation.

### BRIEF DESCRIPTION OF THE DRAWINGS

FIG. 1 is a cross sectional diagram of the planar transformer of the related art.

FIG. 2A is an exploded diagram of the planar transformer of the first embodiment in the disclosure.

FIG. 2B is a cross sectional diagram along line A-A in FIG. 2A of the planar transformer.

FIG. 3 is an exploded diagram of the variant embodiment of the planar transformer of the first embodiment in the disclosure.

FIG. 4 is an exploded diagram of the planar transformer of the second embodiment in the disclosure.

FIG. 5 is an exploded diagram of the planar transformer of the third embodiment in the disclosure.

FIG. 6 is an exploded diagram of the planar transformer of the fourth embodiment in the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

The wordings, such as “first”, “second”, etc., are used in the description to describe some of the element, assembly, area, layer, and/or part, and the element, assembly, area, layer, and/or part are not limited by the wordings. The wordings are merely used to distinguish one of the elements, assemblies, areas, layers, or parts from the other one of those. The wordings, such as “first”, “second”, etc., used in the description do not implicitly indicate any order or sequence except when the context explicitly indicate that.

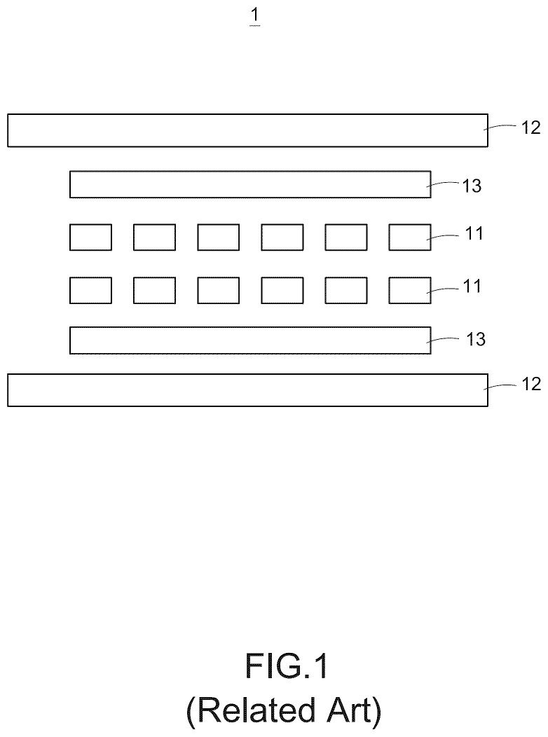

FIG. 1 is a cross sectional diagram of the planar transformer of the related art. As shown in FIG. 1, the planar transformer 1 of the related art includes a primary winding layer 11, a secondary winding layer 12, and a shielding layer 13. The planar transformer 1 of the related art has two primary winding layers 11. In the primary winding layer 11, the wiring of the primary winding is structured by arranging six turns of conductive wires. The planar transformer 1 of the related art has two secondary winding layers 12 located on the topmost layer and the bottommost layer. Further, in each secondary winding layers 12, the wiring of the secondary winding is structured by one turn of conductive wire. The planar transformer 1 of the related art has two shielding layers located between each primary winding layer 11 and each secondary winding layer 12, respectively. The shielding layers 13 are formed with conductor. The rectangle of each shielding layer 13 indicates the cross section of the conductor.

In the planar transformer 1 of the related art, the total distributed capacitance between the primary side and the secondary side are contributed by the distributed capacitance C1 between the primary winding layer 11 and the shielding layer 13, the distributed capacitance C2 between the secondary winding layer 12 and the shielding layer 13, and the distributed capacitance C3 between the primary winding layer 11 and the secondary winding layer 12.

However, the planar transformer 1 is a multi-layer plate, and the deviation may unavoidably occur for the relative position between different layers during the manufacturing process. The deviation may cause any one of the contribution parts C1, C2, and/or C3 of the total distributed capacitance to be changed, and further cause deviation to the total distributed capacitance. Further, in the structure of the planar transformer 1 of the related art, the interlayer capacitance from the shielding layer 13 may influence the switching speed of the switching power supply under high-frequency operation, and further decrease the operation efficiency.

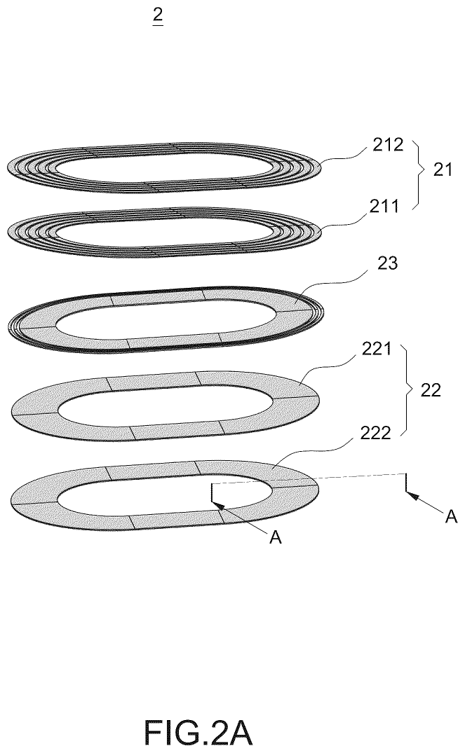

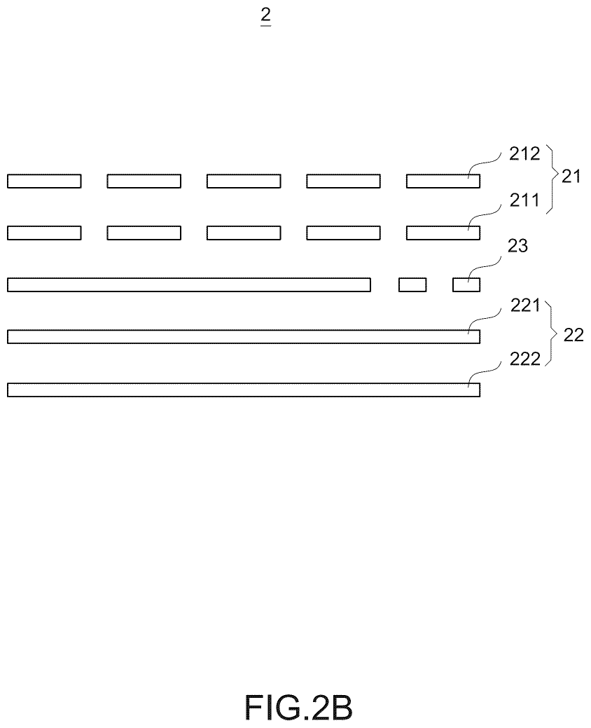

FIG. 2A is an exploded diagram of the planar transformer 2 of the first embodiment in the disclosure. FIG. 2B is a cross sectional diagram along line A-A in FIG. 2A of the planar transformer 2. The planar transformer 2 of the embodiment includes a primary winding set 21, a secondary winding set 22, and a shielding layer 23. The planar transformer 2 is, for example, the printed circuit board (PCB) planar transformer. In some embodiments, the primary winding set 21, the secondary winding set 22, and the shielding layer 23 are disposed on the printed circuit board (not shown in figures).

The primary winding set 21 includes at least two primary winding layers. In some embodiments, the primary winding set 21 has, for example, a first primary winding layer 211 and a second primary winding layer 212. The second primary winding layer 212 is disposed adjacent to the first primary winding layer 211. Further, the first primary winding layer 211 is located at one side of the shielding layer 23. The second primary winding layer 212 is located at the other side of the first primary winding layer 211 opposite to the shielding layer 23. In other words, the first primary winding layer 211 and the second primary winding layer 212 are located at the same side of the shielding layer 23, and the first primary winding layer 211 is located between the second primary winding layer 212 and the shielding layer 23.

In the first primary winding layer 211 and the second primary winding layer 212, the wirings of the primary windings are respectively structured by arranging five turns of conductive wires. Each rectangle in the first primary winding layer 211 and the second primary winding layer 212 indicates the cross section of one turn of the conductive wire. It should be noted that the turns of the conductive wires in the first primary winding layer 211 and the second primary winding layer 212 are not limiting, different turns may be used depending on different requirements.

The secondary winding set 22 includes at least two secondary winding layers. In some embodiments, the secondary winding set 22 has, for example, a first secondary winding layer 221 and a second secondary winding layer 222. The first secondary winding layer 221 is disposed adjacent to the shielding layer 23. The second secondary winding layer 222 is disposed adjacent to the first secondary winding layer 221. Further, the first secondary winding layer 221 is located at the other side of the shielding layer 23. The second secondary winding layer 222 is located at the other side of the first secondary winding layer 221 opposite to the shielding layer 23. In other words, the first secondary winding layer 221 and the second secondary winding layer 222 are located at the same side of the shielding layer 23, and the first secondary winding layer 221 is located between the second secondary winding layer 222 and the shielding layer 23.

In the first secondary winding layer 221 and the second secondary winding layer 222, the wirings of the primary windings are respectively structured by one turn of conductive wire. Each rectangle in the first secondary winding layer 221 and the second secondary winding layer 222 indicates the cross section of one turn of the conductive wire. It should be noted that the turns of the conductive wires in the first secondary winding layer 221 and the second secondary winding layer 222 are not limiting, different turns may be used depending on different requirements.

The shielding layer 23 is located between the primary winding set 21 and the secondary winding set 22. The shielding layer 23 is disposed adjacent to the first primary winding layer 211 and the first secondary winding layer 221. The first primary winding layer 211 and the second primary winding layer 212 are located at one side of the shielding layer 23, and the first secondary winding layer 221 and the second secondary winding layer 222 are located at the other side of the shielding layer 23. In other words, the primary winding set 21 and the secondary winding set 22 are respectively located at two sides of the shielding layer 23. The shielding layer 23 is formed with conductor. The rectangles of the shielding layer 23 indicate the cross section of the conductor. Here uses one long rectangle and two short rectangles as an example for the cross section of the conductor in the shielding layer 23, here is not intended to be limiting, different designs may be applied with different requirements.

In summary, the planar transformer 2 of the embodiment is structured by respectively arranging two primary winding layers 211, 212 and two secondary winding layers 221, 222 at two sides of one shielding layer 23. As a result, comparing to the related-art structure, the interlayer capacitance from the shielding layer is decreased, the switching speed of the switching power supply may not be influenced under high-frequency operation, and the decreasing of the operation efficiency may be further prevented. Specifically, comparing to the related-art planar transformer (for example, the planar transformer 1 in FIG. 1), the planar transformer 2 of the embodiment may increase the switching speed of the switching power supply by 30% to 40%, decrease the interlayer capacitance between the primary winding layers 211, 212 and the shielding layer 23 by 40% to 50%, and decrease the interlayer capacitance between the secondary winding layers 221, 222 and the shielding layer 23 by 40% to 50%. In other words, the planar transformer 2 of the embodiment may decrease the interlayer capacitance from the shielding layer 23 and decrease the efficiency loss during high-frequency operation.

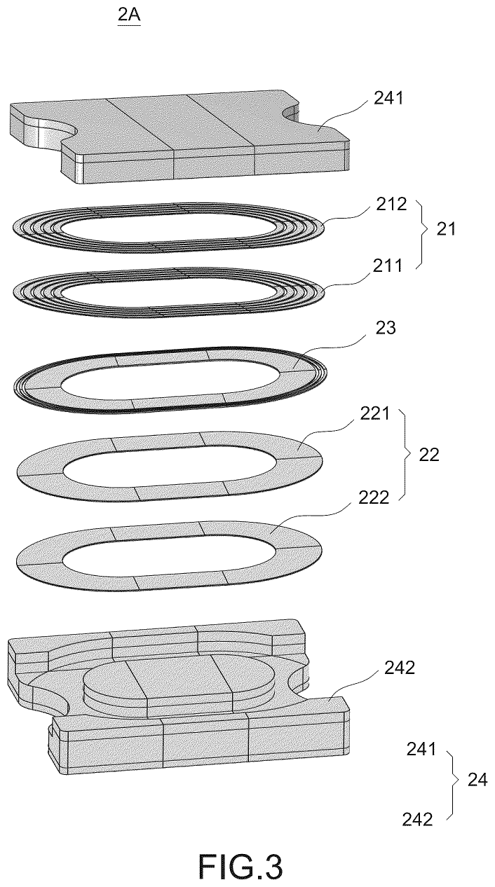

FIG. 3 is an exploded diagram of the variant embodiment of the planar transformer 2A of the first embodiment in the disclosure. In the embodiment, the planar transformer 2A further includes a casing 24. The casing includes an upper casing 241 and a bottom casing 242. The upper casing 241 and the bottom casing 242 cover the primary winding layers 211, 212, the secondary winding layers 221, 222, and the shielding layer 23.

As a result, the planar transformer 2A may be prevented from damage, and the primary winding layers 211, 212 and the secondary winding layers 221, 222 may be prevented from external electromagnetic interference.

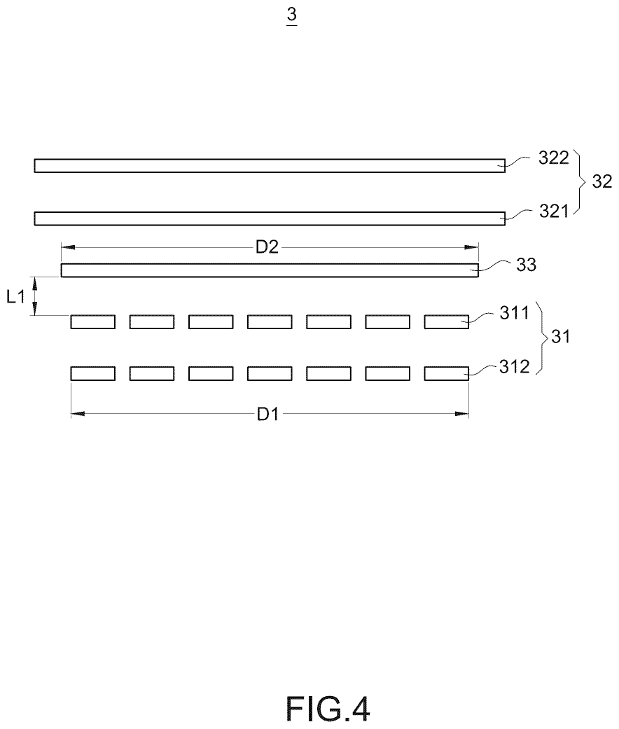

FIG. 4 is an exploded diagram of the planar transformer 3 of the second embodiment in the disclosure. It should be noted that FIG. 4 is the cross-sectional diagram of the planar transformer 3 along, for example, the line A-A in FIG. 2A. The planar transformer 3 of the embodiment includes a primary winding set 31, a secondary winding set 32, and a shielding layer 33. It is worth mentioning that, in FIG. 4, the primary winding set 31 is located under the shielding layer 33, the secondary winding set 32 is located above the shielding layer 33, and that is merely a difference from the observing direction. That is, if the observing direction is upside down, the primary winding set 31 is located above the shielding layer 33, and the secondary winding set 32 is located under the shielding layer 33.

The primary winding set 31 includes at least two primary winding layers. In some embodiments, the primary winding set 31 has, for example, a first primary winding layer 311 and a second primary winding layer 312. The second primary winding layer 312 is disposed adjacent to the first primary winding layer 311. Further, the first primary winding layer 311 is located at one side of the shielding layer 33. The second primary winding layer 312 is located at the other side of the first primary winding layer 311 opposite to the shielding layer 33. In other words, the first primary winding layer 311 and the second primary winding layer 312 are located at the same side of the shielding layer 33, and the first primary winding layer 311 is located between the second primary winding layer 312 and the shielding layer 33.

In the first primary winding layer 311 and the second primary winding layer 312, the wirings of the primary windings are respectively structured by arranging six turns of conductive wires. Each rectangle in the first primary winding layer 311 and the second primary winding layer 312 indicates the cross section of one turn of the conductive wire. It should be noted that the turns of the conductive wires in the first primary winding layer 311 and the second primary winding layer 312 are not limiting, different turns may be used depending on different requirements.

The secondary winding set 32 includes at least two secondary winding layers. In some embodiments, the secondary winding set 32 has, for example, a first secondary winding layer 321 and a second secondary winding layer 322. The first secondary winding layer 321 is disposed adjacent to the shielding layer 33. The second secondary winding layer 322 is disposed adjacent to the first secondary winding layer 321. Further, the first secondary winding layer 321 is located at the other side of the shielding layer 33. The second secondary winding layer 322 is located at the other side of the first secondary winding layer 321 opposite to the shielding layer 33. In other words, the first secondary winding layer 321 and the second secondary winding layer 322 are located at the same side of the shielding layer 33, and the first secondary winding layer 321 is located between the second secondary winding layer 322 and the shielding layer 33.

In the first secondary winding layer 321 and the second secondary winding layer 322, the wirings of the primary windings are respectively structured by one turn of conductive wire. Each rectangle in the first secondary winding layer 321 and the second secondary winding layer 322 indicates the cross section of one turn of the conductive wire. It should be noted that the turns of the conductive wires in the first secondary winding layer 321 and the second secondary winding layer 322 are not limiting, different turns may be used depending on different requirements.

The shielding layer 33 is located between the primary winding set 31 and the secondary winding set 32. The shielding layer 33 is disposed adjacent to the first primary winding layer 311 and the first secondary winding layer 321. The first primary winding layer 311 and the second primary winding layer 312 are located at one side of the shielding layer 33, and the first secondary winding layer 321 and the second secondary winding layer 322 are located at the other side of the shielding layer 33. In other words, the primary winding set 31 and the secondary winding set 32 are respectively located at two sides of the shielding layer 33. The shielding layer 33 is formed with conductor. The rectangles of the shielding layer 33 indicate the cross section of the conductor. Here uses one long rectangle as an example for the cross section of the conductor in the shielding layer 33, here is not intended to be limiting, different designs may be applied with different requirements.

In the embodiment, a distance L1 between the first primary winding layer 311 and the shielding layer 33 is in a predetermined range. The predetermined range of the distance L1 is, for example, equal to or greater than 0.4 mm and equal to or less than 0.6 mm. That is, the first primary winding layer 311 and the shielding layer 33 need to be distanced at least equal to or greater than 0.4. On the other hand, the distance L1 between the first primary winding layer 311 and the shielding layer 33 is desirably equal to or less than 0.6 mm to avoid bulky volume of the planar transformer 3. As a result, the interlayer capacitance from the shielding layer 33 may be further decreased, and the efficiency loss during high-frequency operation may be decreased.

Further, in the embodiment, a lateral width D1 of the first primary winding layer 311 and the second primary winding layer 312 of the primary winding set 31 is less than a lateral width D2 of the shielding layer 33. It should be noted that, in the primary winding layers 311, 312, the wiring of the primary winding is structured by the arranged conductive wire and the gaps therebetween, and the wiring of the primary winding structured by the conductive wire has the lateral width D1.

As a result, even under the condition of the pressing deviation being maximum, the deviation of the total distributed capacitance between the primary winding set 31 and the secondary winding set 32 caused by the pressing deviation may be decreased.

In summary, the planar transformer 3 of the embodiment is structured by respectively arranging two primary winding layers 311, 312 and two secondary winding layers 321, 322 at two sides of one shielding layer 33. As a result, comparing to the related-art structure, the interlayer capacitance from the shielding layer is decreased, the switching speed of the switching power supply may not be influenced under high-frequency operation, and the decreasing of the operation efficiency may be further prevented. Further, with the distance L1 between the first primary winding layer 311 and the shielding layer 33 being set to be in a predetermined range, the interlayer capacitance from the shielding layer 33 may be further decreased, and the efficiency loss during high-frequency operation may be decreased. Moreover, with the lateral width D1 of the primary winding set 31 being set to be less than the lateral width D2 of the shielding layer 33, the deviation of the total distributed capacitance between the primary winding set 31 and the secondary winding set 32 caused by the pressing deviation may be decreased.

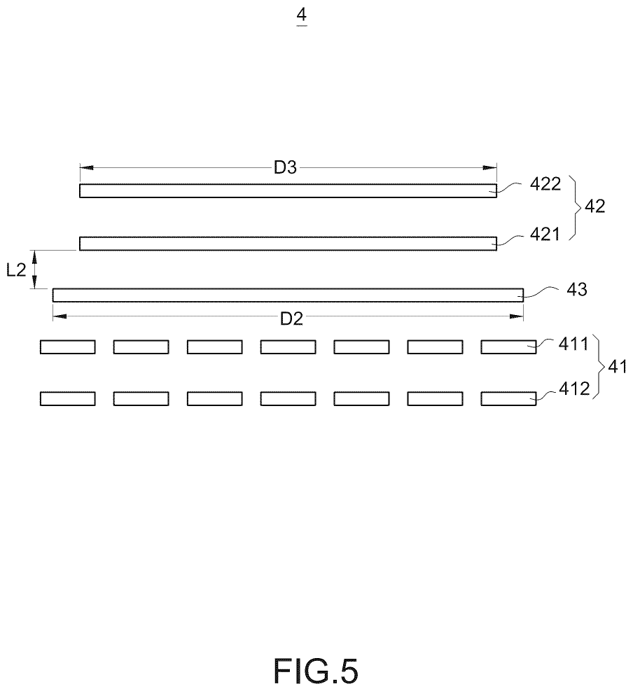

FIG. 5 is an exploded diagram of the planar transformer 4 of the third embodiment in the disclosure. It should be noted that FIG. 5 is the cross-sectional diagram of the planar transformer 4 along, for example, the line A-A in FIG. 2A. The planar transformer 4 of the embodiment includes a primary winding set 41, a secondary winding set 42, and a shielding layer 43. The primary winding set 41 has, for example, a first primary winding layer 411 and a second primary winding layer 412. The secondary winding set 42 has, for example, a first secondary winding layer 421 and a second secondary winding layer 422. The shielding layer 43 is located between the primary winding set 41 and the secondary winding set 42. The shielding layer 43 is disposed adjacent to the first primary winding layer 411 and the first secondary winding layer 421. The difference between the planar transformer 4 of the embodiment and the aforementioned planar transformer 3 is that a distance L2 between the first secondary winding layer 421 and the shielding layer 43 is in a predetermined range, and a lateral width D3 of the first secondary winding layer 421 and the second secondary winding layer 422 of the secondary winding set 42 is less than the lateral width D2 of the shielding layer 43.

Specifically, the predetermined range of the distance L2 is, for example, equal to or greater than 0.4 mm and equal to or less than 0.6 mm. That is, the first secondary winding layer 421 and the shielding layer 43 need to be distanced at least equal to or greater than 0.4. On the other hand, the distance L2 between the first secondary winding layer 421 and the shielding layer 43 is desirably equal to or less than 0.6 mm to avoid bulky volume of the planar transformer 4. As a result, the interlayer capacitance from the shielding layer 43 may be further decreased, and the efficiency loss during high-frequency operation may be decreased.

In summary, the planar transformer 4 of the embodiment is structured by respectively arranging two primary winding layers 411, 412 and two secondary winding layers 421, 422 at two sides of one shielding layer 43. As a result, comparing to the related-art structure, the interlayer capacitance from the shielding layer is decreased, the switching speed of the switching power supply may not be influenced under high-frequency operation, and the decreasing of the operation efficiency may be further prevented. Further, with the distance L2 between the first secondary winding layer 421 and the shielding layer 43 being set to be in a predetermined range, the interlayer capacitance from the shielding layer 43 may be further decreased, and the efficiency loss during high-frequency operation may be decreased. Moreover, with the lateral width D3 of the secondary winding set 42 being set to be less than the lateral width D2 of the shielding layer 43, the deviation of the total distributed capacitance between the primary winding set 41 and the secondary winding set 42 caused by the pressing deviation may be decreased.

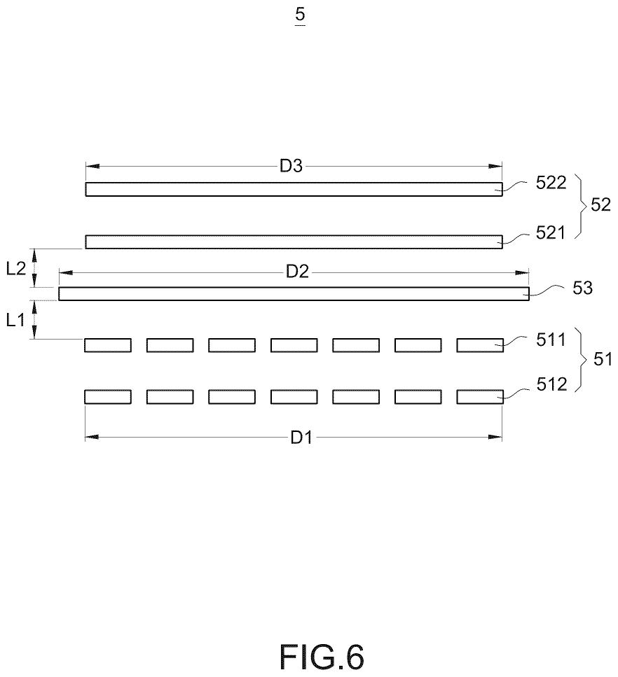

FIG. 6 is an exploded diagram of the planar transformer 5 of the fourth embodiment in the disclosure. It should be noted that FIG. 6 is the cross-sectional diagram of the planar transformer 5 along, for example, the line A-A in FIG. 2A. The planar transformer 5 of the embodiment includes a primary winding set 51, a secondary winding set 52, and a shielding layer 53. The primary winding set 51 has, for example, a first primary winding layer 511 and a second primary winding layer 512. The secondary winding set 52 has, for example, a first secondary winding layer 521 and a second secondary winding layer 522. The shielding layer 53 is located between the primary winding set 51 and the secondary winding set 52. The shielding layer 53 is disposed adjacent to the first primary winding layer 511 and the first secondary winding layer 521. The difference between the planar transformer 5 of the embodiment and the aforementioned planar transformers 3, 4 is that the distance L1 between the first primary winding layer 511 and the shielding layer 53 is in a predetermined range, the distance L2 between the first secondary winding layer 521 and the shielding layer 53 is in a predetermined range, and the lateral widths D1, D3 of the primary winding set 51 and the secondary winding set 52 both are less than the lateral width D2 of the shielding layer 53.

Specifically, the predetermined range of the distances L1, L2 is, for example, equal to or greater than 0.4 mm and equal to or less than 0.6 mm. That is, the first primary winding layer 511 and the first secondary winding layer 521 respectively need to be distanced from the shielding layer 53 for at least equal to or greater than 0.4. On the other hand, the distances L1, L2 are desirably equal to or less than 0.6 mm to avoid bulky volume of the planar transformer 5. As a result, the interlayer capacitance from the shielding layer 53 may be further decreased, and the efficiency loss during high-frequency operation may be decreased.

It is worth mentioning that the distance L1 between the first primary winding layer 511 and the shielding layer 53 may be the same with or different from the distance L2 between the first secondary winding layer 521 and the shielding layer 53, here is not intended be limiting.

In summary, with the distance L1 between the first primary winding layer 511 and the shielding layer 53 being set to be in the predetermined range, and the distance L2 between the first secondary winding layer 521 and the shielding layer 53 being set to be in the predetermined range, the interlayer capacitance from the shielding layer 53 may be further decreased, and the efficiency loss during high-frequency operation may be decreased. Moreover, with the lateral width D1 of the primary winding set 51 and the lateral width D3 of the secondary winding set 52 both being set to be less than the lateral width D2 of the shielding layer 53, the deviation of the total distributed capacitance between the primary winding set 51 and the secondary winding set 52 caused by the pressing deviation may be decreased.

It should be noted that the combinations of the lateral width of the primary winding set being less than the lateral width of the shielding layer (hereafter as feature 1), the lateral width of the secondary winding set being less than the lateral width of the shielding layer (hereafter as feature 2), the distance between the first primary winding layer and the shielding layer being in the predetermined range (hereafter as feature 3), and the distance between the first secondary winding layer and the shielding layer being in the predetermined range (hereafter as feature 4) are not limited to the aforementioned embodiments. In other words, feature 1 may be used with feature 4, or feature 2 may be used with feature 3.

In summary, the planar transformer of the disclosure is structured by respectively arranging two primary winding layers and two secondary winding layers at two sides of one shielding layer. As a result, comparing to the related-art structure, the interlayer capacitance from the shielding layer is decreased, the switching speed of the switching power supply may not be influenced under high-frequency operation, and the decreasing of the operation efficiency may be further prevented. Specifically, comparing to the related-art planar transformer, the planar transformer of the disclosure may increase the switching speed of the switching power supply by 30% to 40%, decrease the interlayer capacitance between the primary winding layers and the shielding layer by 40% to 50%, and decrease the interlayer capacitance between the secondary winding layers and the shielding layer by 40% to 50%. In other words, the planar transformer of the disclosure may decrease the interlayer capacitance from the shielding layer and decrease the efficiency loss during high-frequency operation.

Further, with the distance between the first primary winding layer and the shielding layer and/or the distance between the first secondary winding layer and the shielding layer being set to be in the predetermined range, the interlayer capacitance from the shielding layer may be further decreased, and the efficiency loss during high-frequency operation may be decreased. Moreover, with the lateral width of the primary winding set and/or the lateral width of the secondary winding set being set to be less than the lateral width of the shielding layer, the deviation of the total distributed capacitance between the primary winding set and the secondary winding set caused by the pressing deviation may be decreased.

While this disclosure has been described by means of specific embodiments, numerous modifications and variations may be made thereto by those skilled in the art without departing from the scope and spirit of this disclosure set forth in the claims.

What is claimed is:

1. A planar transformer, comprising:
a first primary winding layer;
a second primary winding layer, disposed adjacent to the first primary winding layer;
a shielding layer, disposed adjacent to the first primary winding layer;
a first secondary winding layer, disposed adjacent to the shielding layer; and
a second secondary winding layer, disposed adjacent to the first secondary winding layer,
wherein the first primary winding layer and the second primary winding layer are located at one side of the shielding layer, and the first secondary winding layer and the second secondary winding layer are located at another side of the shielding layer.

2. The planar transformer of claim 1, wherein a distance between the first primary winding layer and the shielding layer is in a predetermined range.

3. The planar transformer of claim 2, wherein the predetermined range is equal to or greater than 0.4 mm and equal to or less than 0.6 mm.

4. The planar transformer of claim 1, wherein a distance between the first secondary winding layer and the shielding layer is in a predetermined range.

5. The planar transformer of claim 4, wherein the predetermined range is equal to or greater than 0.4 mm and equal to or less than 0.6 mm.

6. The planar transformer of claim 1, wherein a distance between the first primary winding layer and the shielding layer is same with a distance between the first secondary winding layer and the shielding layer.

7. The planar transformer of claim 1, wherein a lateral width of the first primary winding layer is less than a lateral width of the shielding layer.

8. The planar transformer of claim 1, wherein a lateral width of the first secondary winding layer is less than a lateral width of the shielding layer.

9. A planar transformer, comprising:
a shielding layer;
a first primary winding layer, located at one side of the shielding layer;
a first secondary winding layer, located at another side of the shielding layer;
a second primary winding layer, located one side of the first primary winding layer opposite to the shielding layer; and
a second secondary winding layer, located one side of the first secondary winding layer opposite to the shielding layer.

10. The planar transformer of claim 9, wherein a distance between the first primary winding layer and the shielding layer is in a predetermined range.

11. The planar transformer of claim 10, wherein the predetermined range is equal to or greater than 0.4 mm and equal to or less than 0.6 mm.

12. The planar transformer of claim 9, wherein a distance between the first secondary winding layer and the shielding layer is in a predetermined range.

13. The planar transformer of claim 12, wherein the predetermined range is equal to or greater than 0.4 mm and equal to or less than 0.6 mm.

14. The planar transformer of claim 9, wherein a distance between the first primary winding layer and the shielding layer is same with a distance between the first secondary winding layer and the shielding layer.

15. The planar transformer of claim 9, wherein a lateral width of the first primary winding layer is less than a lateral width of the shielding layer.

16. The planar transformer of claim 9, wherein a lateral width of the first secondary winding layer is less than a lateral width of the shielding layer.

17. A planar transformer, comprising:
a primary winding set, comprising at least two primary winding layers;
a secondary winding set, comprising at least two secondary winding layers; and
a shielding layer, located between the primary winding set and the secondary winding set.

18. The planar transformer of claim 17, wherein a distance between the primary winding set and the shielding layer is in a predetermined range.

19. The planar transformer of claim 17, wherein a distance between the secondary winding set and the shielding layer is in a predetermined range.

20. The planar transformer of claim 17, wherein a distance between the primary winding set and the shielding layer is same with a distance between the secondary winding set and the shielding layer.
